(19) United States
(12) Patent Application Publication
(10) Pub. No.: US 2009/0197986 A1
(43) Pub. Date: Aug. 6, 2009

(54) Polymerizable optical composition, optical sheet and method for making the optical sheet

(76) Inventors: Kuang-Rong Lee, Tainan City (TW); Wun-Wei Hu, Tainan City (TW); Ming-Hui Tseng, Tainan City (TW)

Correspondence Address: KNOBBE MARTENS OLSON & BEAR LLP, 2040 MAIN STREET, FOURTEENTH FLOOR, IRVINE, CA, 92614, US

(21) Appl. No.: 12/218,168

(22) Filed: Jul. 11, 2008

(30) Foreign Application Priority Data
Feb. 4, 2008 (TW) 097104210

(51) Int. Cl. G02B 5/02; C08F 14/18; C08K 5/21; B05D 5/06

(52) U.S. Cl. 522/6; 359/599; 526/242; 524/199; 427/162

(57) ABSTRACT

A polymerizable optical composition includes first and second monomers. The weight ratio of the first monomer to the second monomer is from 1:9 to 9:1. The second monomer contains at least one acryl functional group. The first monomer is represented by a formula [A]:

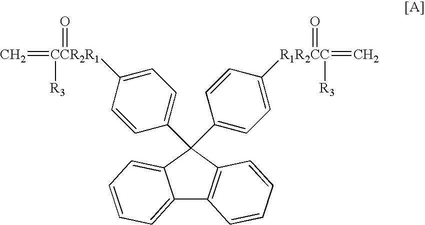

wherein R₁ is selected from one of O and S atoms; R₂ is a bivalent functional group of (C₂H₄O)ₙ, where n is an integer from 1 to 10; and R₃ is selected from one of H and CH₃.

### CROSS-REFERENCE TO RELATED APPLICATION

This application claims priority of Taiwanese application no. 097104210, filed on Feb. 4, 2008.

### BACKGROUND OF THE INVENTION

1. Field of the Invention

The invention relates to a polymerizable optical composition utilized in forming a brightness enhancement film of an optical sheet, and a method for making the optical sheet.

2. Description of the Related Art

A brightness enhancement film (hereinafter referred to as BEF) of an optical sheet is utilized in a display, for example, a liquid crystal display (LCD). The BEF is used to refract and reflect a light from a backlight module of the display and to direct the light in a viewing angle of a user to enhance the brightness of the display. Therefore, the utilization efficiency of the light can be improved and the degradation of the display due to the heat converted from the light can be alleviated.

Formation of the BEF is normally conducted by coating a polymerizable optical composition (liquid state) containing at least one acryl monomer on a substrate, followed by curing the composition using UV light so as to form the BEF on the substrate. By making the refractive index of the BEF higher, a brighter display can be achieved. Therefore, in order to obtain a BEF with a higher refractive index, it is practicable to utilize a composition with a high refractive index to form the BEF, especially since the refractive index of a BEF can be estimated by measuring the refractive index of the optical composition (liquid state) employed in forming the BEF.

Normally, the composition used in the optical sheet mainly comprises phenylthio-series acryl monomers with high refractive indices, such as phenylthioethyl acrylate (PTEA). The composition may further comprise an acryl monomer having bisphenol A group and/or an oligomer of epoxy acrylate. Nevertheless, the refractive index of the BEF achieved by using the composition of the prior art is less than 1.55. Finding a specific monomer from all known acryl monomers is relatively difficult since the use of an acryl monomer with a high refractive index does not necessarily result in a BEF with a high refractive index.

Furthermore, it is known in the art that the BEF with a higher refractive index can be obtained by including an oligomer substituted by halogen(s), such as a bromine, in the composition having the phenylthio-series acryl monomers, as described in US 2006/0199095 A1, US 2006/0069222 A1, US 7087659 B2, US 6833391 B1, US 2004/0242720 A1, and US 2006/0293463 A1. However, the presence of halogen(s) in the BEF incurs environmental concerns.

Moreover, diphenyl sulfide series acryl monomers, for example, 4,4′-bis(methacroylthio)diphenyl sulfide (MPSMA) are combined with acryl monomers for the composition of the BEF as described in EP 0735062 A1 and U.S. Pat. No. 5,969,867. Although MPSMA is free from the environmental problem concerning the presence of halogen in the BEF, MPSMA is relatively expensive and is required to combine with specific acryl monomers to form the composition of the BEF.

### SUMMARY OF THE INVENTION

Therefore, an object of the present invention is to provide a polymerizable optical composition that can overcome the aforesaid drawbacks associated with the prior art.

Accordingly, a polymerizable optical composition of the present invention comprises first and second monomers. The weight ratio of the first monomer to the second monomer is from 1:9 to 9:1. The second monomer contains at least one acryl functional group, the first monomer being represented by a formula [A]:

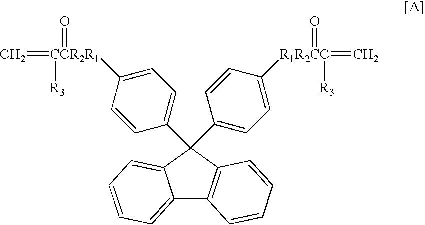

wherein R₁ is selected from one of O and S atoms; R₂ is a bivalent functional group of (C₂H₄O)ₙ, where n is an integer from 1 to 10; and R₃ is selected from one of H and CH₃.

### DETAILED DESCRIPTION OF THE PREFERRED EMBODIMENT

A polymerizable optical composition of the present invention comprises first and second monomers. The weight ratio of the first monomer to the second monomer is from 1: 9 to 9: 1. The second monomer contains at least one acryl functional group. The first monomer is represented by a formula [A]:

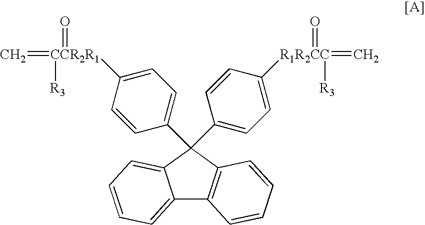

wherein R₁ is selected from one of O and S atoms; R₂ is a bivalent functional group of (C₂H₄O)ₙ, where n is an integer from 1 to 10; and R₃ is selected from one of H and CH₃.

The first monomer of formula [A] can be synthesized in a conventional manner. The polymerization of the composition (i.e., the curing process) is carried out through the acryl groups of the first and second monomers to form the BEF of the optical sheet. The first monomer with R₁ being S atom has a higher refractive index than that with R₁ being O atom.

The first monomer has a higher viscosity and a higher refractive index than those of the second monomer, and the second monomer serves as a “solvent” in the composition for decreasing the viscosity of the composition. The second monomer preferably has a refractive index larger than 1.45 and a viscosity less than 100 cps. When the weight ratio of the first monomer to the second monomer is larger than 9:1, the viscosity of the composition is too high (even larger than 30000 cps) On the other hand, when the weight ratio is less than 1:9, the refractive index of the composition decreases considerably. Therefore, the weight ratio of the first monomer to the second monomer is preferably within the range from1:9-9:1. Preferably, the viscosity of the composition ranges from 40 to 25000 cps. More preferably, the viscosity of the composition ranges from 50 to 15000 cps.

In the preferred embodiment, the first monomer is 9,9-bis[4-(2-acryloyloxy ethoxy)phenyl]fluorene, i.e., in formula [A], R₁ is O atom, R₂ is C₂H₄O group, R₃ is H atom, and the refractive index thereof is 1.615.

Furthermore, the second monomer is preferably selected from the group consisting of a mono-acrylate, a mono-methacrylate, a di-acrylate, a di-methacrylate, and combinations thereof.

Preferably, the mono-acrylate is phenylthioethyl acrylate (PTEA), 2-phenoxyethyl acrylate (PEA), naphthalenylthioethyl acrylate (NTEA), phenoxy diethyleneglycol acrylate, phenoxy polyethyleneglycol acrylate, hexadecyl acrylate, neopentyl glycol propoxylate diacrylate, lauryl acrylate, or combinations thereof.

The mono-methacrylate is preferably 2-phenoxyethyl methacrylate (PEMA), phenylthioethyl methacrylate (PTEMA), methoxy polyethyleneglycol methacrylate, or combinations thereof.

The di-acrylate is preferably polyethyleneglycol diacrylate, 1,10-decanediol diacrylate, ethoxylated cyclohexane dimethanol diacrylate, ethoxylated 2-methyl-1,3-propanediol diacrylate, or combinations thereof.

The di-methacrylate is preferably ethyleneglycol dimethacrylate, diethyleneglycol dimethacrylate, triethyleneglycol dimethacrylate, polyethyleneglycol dimethacrylate, 1,3-butanediol dimethacrylate, 1,6-hexanediol dimethacrylate, or combinations thereof.

More preferably, the mono-acrylate is PTEA, PEA, NTEA, or combinations thereof, and the mono-methacrylate is PEMA, PTEMA, or combinations thereof.

Most preferably, the second monomer is PTEA, PEA, NTEA, PTEMA, or combinations thereof.

In this embodiment, the composition further comprises an additive. The additive is a thickener, a leveling agent, a lubricant, an antistatic agent, a defoamer, an UV absorber, or combinations thereof.

Preferably, the thickener is an aliphatic urethane diacrylate, an aliphatic urethane triacrylate, a low acid value adhesion promoter, or combinations thereof.

To prevent the refractive index of the composition from being undesirably decreased, the additive is in an amount less than 10 wt % based on the total weight of the composition.

A method for making an optical sheet of the present invention comprises: preparing a mixture of the composition of the present invention and a photo-initiator; applying the mixture on a substrate; and curing the mixture.

In this embodiment, the photo-initiator is in an amount ranging from 1 to 15wt% based on the total weight of the mixture.

Preferably, the photo-initiator is 1-hydroxy-cyclohexyl-phenyl-ketone, 2-methyl-1-[4-(methylthio)phenyl]-2-(4-morpholinyl)-1-propanone, phenyl-bis(2,4,6-trimethylbenzoyl)phosphine oxide, diphenyl(2,4,6-trimethylbenzoyl)-phosphine oxide, 2-hydroxy-2-methyl-1-phenyl-1-propanone, or combinations thereof.

The curing step is conducted using an UV light. Preferably, the wavelength of the UV light is in a range from 240 nm to 360 nm, and that the intensity of the UV light is in a range from 1˜1000 mJ/cm². More preferably, the intensity of the UV light is in a range from 100˜500 mJ/cm².

An optical sheet of the present invention comprises a substrate and the BEF formed on the substrate. The BEF is formed by: applying the mixture of the composition of the present invention and the photo-initiator on the substrate; and curing the mixture to form the BEF on the substrate.

Preferably, the BEF has a layer thickness ranging from 10 μm to 30 μm.

The substrate should not be limited to a specific material. However, when the optical sheet is to be used in a liquid crystal display, the substrate should be transparent and is preferably made from a material of polyethylene terephthalate (PET), polyethylene naphthalate (PEN), polyimide (PI), polycarbonate (PC), or polymethyl methacrylate (PMMA). Preferably, the layer thickness of the substrate ranges from 16 μm to 250 μm.

Alternatively, the substrate is composed of a transparent plastic sheet and a diffusion layer disposed on the sheet and capable of scattering light passing therethrough.

### EXAMPLES & COMPARATIVE EXAMPLE

The present invention is explained in more detail below by way of the following examples and comparative example. The monomers, additives, photo-initiator, and substrate given in the examples and the comparative example are as follows.

Monomer
(1) A-BPEF: 9,9-bis[4-(2-acryloyloxy ethoxy)phenyl]fluorene (Japan Shinnakamura Chemical Co., trade name: A-BPEF)
(2) BPEF-A: 9,9-bis[4-(2-acryloyloxy ethoxy)phenyl]fluorene (Japan Osaka Gas Chemical Co., tradename: BPEF-A)
(3) F5003: 9,9-bis[4-(2-acryloyloxy ethoxy)phenyl]fluorene (Japan Osaka Gas Chemical Co., tradename: EA-F5003)
(4) PTEA: Bimax Co.
(5) PEA: Sartomer Co., trade name: SR339.
(6) NTEA: Daelim Chemical Electromer Co., trade name: HRI-02.
(7) PTEMA: Cognis Co., trade name: Bisomer PTEA.
(8) B200: ethoxylated bisphenol A dimethacrylate (Japan Shinnakamura Chemical Co., trade name:

BPE-200, refractive index: 1.532, and viscosity:

600 cps)

Additive (Thickener)
(9) P6210: Aliphatic urethane diacrylate (Cognis Co., trade name: Photomer 6210).
(10) P6230: Aliphatic urethane diacrylate (Cognis Co., trade name: Photomer 6230).
(11) P4846: Low acid value adhesion promoter (Cognis Co., trade name: Photomer 4846).
(12) P6892: Aliphatic urethane triacrylate (Cognis Co., trade name: Photomer 6892).

Photo-Initiator
(13) I184: 1-hydroxy-cyclohexyl-phenyl-ketone (Ciba Co., trade name: Irgacure 184).
(14) I907: 2-methyl-1-[4-(methylthio)phenyl]-2-(4-morpholinyl)-1-propanone (Ciba Co., trade name: Irgacure 907).
(15) I819: phenyl-bis(2,4,6-trimethylbenzoyl)phosphine oxide (Ciba Co., trade name: Irgacure 819).
(16) TPO: diphenyl(2,4,6-trimethylbenzoyl)-phosphine oxide (Ciba Co., trade name: Darocure TPO).

Substrate
(17) PET: thickness 188 μm.

The compositions and the optical sheets of the examples and the comparative example were evaluated according the following methods, and the results are given in Table 1.

Compositions (Liquid State)

(1) Viscosity

The viscosity of the composition for each example and comparative example was evaluated using a viscosimeter (BrookField Co., model: DV-I+) at 25° C.

(2) Refractive Index

The refractive index of the composition for each example and comparative example was evaluated through an Abbe refractometer (ATAGO co.) using a light of a wavelength of 589 nm at 20° C.

Optical Sheets

(3) Adhesion

Adhesion of the BEF to the substrate was determined according to a method defined in ASTM D3359-02 using a cross-cut tester (Zehntner Co., model: ZCC 2087). The adhesion was evaluated in scales of 0B˜5B, in which 5B represents a highest adhesion, and 0B represents a lowest adhesion. The acceptable value of adhesion is at least 3B, i.e., the peel-off rate ranges from 5% to 15%.

(4) Brightness

The brightness of the optical sheet was measured by a brightness photo meter (Topcon Co., model: SR3A) using a backlight with a brightness of 3420 nits provided by a standard backlight of EFUN Technology Co., Ltd.

(5) Reliability

The reliability of the optical sheet was evaluated by measuring the brightness after one of the following tests. A higher brightness means a longer service life of the optical sheet:

(a) thermal test: disposing the optical sheet in a chamber with a working temperature of 85° C. for 500 hours.

(b) humidity test: disposing the optical sheet in a chamber with a working temperature of 65° C. and a humidity of 95% for 500 hours.

After preparing the mixture having one of the above-mentioned photo-initiator and at least one of the monomers, coating the mixture on a PET substrate, and curing the mixture using an UV light with a wavelength ranging from 240 nm to 360 nm for 10 seconds, the optical sheet for each of the examples and the comparative example can be obtained. The layer thickness of the BEF thus formed is about 25 μm for each of the examples and the comparative example.

TABLE 1

| | Amount of each | | | | | | Test result of the | | | |
|---|---|---|---|---|---|---|---|---|---|---|
| | component | | | | | | optical sheet | | | |
| | (wt %) | | | | | Photo- | | | Reliability | |
| | First | Second | | Viscosity | Refractive | initiator | | | Thermal | Humidity |
| | monomer | monomer | Thickener | (cps) | index | (wt %) | Brightness | Adhesion | test | test |
| Ex. 1 | A-BPEF | PTEA | P6210 | 50 | 1.560 | I184 | 5380 | 3B | 5300 | 5295 |
| | (10) | (85) | (5) | | | (5) | | | | |
| Ex. 2 | A-BPEF | PTEA | P6210 | 350 | 1.580 | I184 | 5545 | 5B | 5445 | 5460 |
| | (45) | (50) | (5) | | | (5) | | | | |
| Ex. 3 | A-BPEF | PTEA | P6210 | 3000 | 1.593 | I184 | 5650 | 5B | 5570 | 5565 |
| | (65) | (30) | (5) | | | (5) | | | | |
| Ex. 4 | A-BPEF | PTEA | — | 15000 | 1.603 | I184 | 5700 | 4B | 5603 | 5611 |
| | (80) | (20) | | | | (5) | | | | |
| Ex. 5 | BPEF-A | PTEMA | P6230 | 500 | 1.572 | I907 | 5470 | 5B | 5394 | 5416 |
| | (45) | (45) | (10) | | | (6) | | | | |
| Ex. 6 | BPEF-A | NTEA | P6892 | 250 | 1.614 | I819 | 5808 | 5B | 5701 | 5715 |
| | (45) | (50) | (5) | | | (3) | | | | |
| Ex. 7 | F5003 | PEA | P4846 | 200 | 1.550 | TPO | 5316 | 5B | 5250 | 5263 |
| | (55) | (44) | (1) | | | (4) | | | | |
| Comp. | B200 | PEA | P6210 | 200 | 1.526 | I184 | 5095 | 3B | 5011 | 5002 |
| Exam. | (80) | (15) | (5) | | | (5) | | | | |

As shown in Table 1, the optical sheets of the examples of the present invention have better required properties, such as brightness and refractive index, than those of the comparative example. For example, the refractive indices of the examples are larger than 1.550 and the brightness thereof ranges from5316to5808 nits. However, in the comparative example, the refractive index is lower than 1.550 and the brightness is 5095 nits.

Note that although no thickener was added in the composition of Example 4, an adhesion of degree “4B” for the BEF of Example 4 was obtained. That is to say, the peel-off rate of the optical sheet of Example 4 was less than 5% in the adhesion test defined in ASTM D3359-02.

It is noted that even after adding the thickener in the composition of the comparative example, the adhesion of the BEF to the substrate was only in the degree of “3B”. Needless to say, the adhesion of the comparative example was poor when no thickener added.

Moreover, after the reliability tests (thermal or humidity test), the brightness for each of the optical sheets of the examples can be maintained at substantially the same level as that thereof before the tests. The brightness of the optical sheet of the comparative example (which was measured before the reliability test) was even lower than those of the examples, which were measured after the reliability test. Hence, the optical sheets of the present invention have better reliability and can be used for a longer service time.

With the inclusion of the first monomer in the composition of the present invention, the aforesaid drawbacks associated with the prior art can be eliminated. Therefore, an optical sheet having a high refractive index, a high brightness, and good reliability, without using halogen(s) can be achieved by the present invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A polymerizable optical composition comprising first and second monomers, the weight ratio of said first monomer to said second monomer being from 1:9 to 9:1, said second monomer containing at least one acryl functional group, said first monomer being represented by a formula [A]: 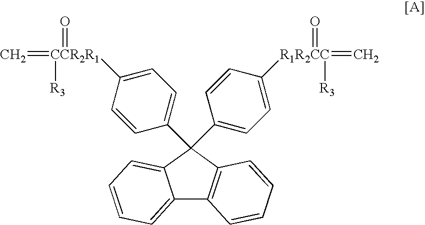
wherein R₁ is selected from one of O and S atoms; R₂ is a bivalent functional group of (C₂H₄O) n where n is an integer from 1 to 10; and R₃ is selected from one of H and CH₃.

2. The polymerizable optical composition of claim 1, wherein said second monomer has a reflective index larger than 1.45 and a viscosity less than 100 cps.

3. The polymerizable optical composition of claim 1, wherein said first monomer is 9,9-bis[4-(2-acryloyloxy ethoxy)phenyl]fluorene.

4. The polymerizable optical composition of claim 1, wherein said second monomer is selected from the group consisting of a mono-acrylate, a mono-methacrylate, a di-acrylate, a di-methacrylate, and combinations thereof.

5. The polymerizable optical composition of claim 4, wherein said mono-acrylate is selected from the group consisting of phenylthioethyl acrylate, 2-phenoxyethyl acrylate, naphthalenylthioethyl acrylate, phenoxy diethyleneglycol acrylate, phenoxy polyethyleneglycol acrylate, hexadecyl acrylate, neopentyl glycol propoxylate diacrylate, lauryl acrylate, and combinations thereof.

6. The polymerizable optical composition of claim 4, wherein said mono-methacrylate is selected from the group consisting of 2-phenoxyethyl methacrylate, phenylthioethyl methacrylate, methoxy polyethyleneglycol methacrylate, and combinations thereof.

7. The polymerizable optical composition of claim 4, wherein said di-acrylate is selected from the group consisting of polyethyleneglycol diacrylate, 1,10-decanediol diacrylate, ethoxylated cyclohexane dimethanol diacrylate, ethoxylated 2-methyl-1,3-propanediol diacrylate, and combinations thereof.

8. The polymerizable optical composition of claim 4, wherein said di-methacrylate is selected from the group consisting of ethyleneglycol dimethacrylate, diethyleneglycol dimethacrylate, triethyleneglycol dimethacrylate, polyethyleneglycol dimethacrylate, 1,3-butanediol dimethacrylate, 1,6-hexanediol dimethacrylate, and combinations thereof.

9. The polymerizable optical composition of claim 4, wherein said mono-acrylate is selected from the group consisting of phenylthioethyl acrylate, 2-phenoxyethyl acrylate, naphthalenylthioethyl acrylate, and combinations thereof; and wherein said mono-methacrylate is selected from the group consisting of 2-phenoxyethyl methacrylate, phenylthioethyl methacrylate, and combinations thereof.

10. The polymerizable optical composition of claim 1, further comprising an additive selected from the group consisting of a thickener, a leveling agent, a lubricant, an antistatic agent, a defoamer, an UV absorber, and combinations thereof.

11. The polymerizable optical composition of claim 10, wherein said thickener is selected from the group consisting of an aliphatic urethane diacrylate, an aliphatic urethane triacrylate, a low acid value adhesion promoter, and combinations thereof.

12. The polymerizable optical composition of claim 10, wherein said additive is in an amount less than 10 wt % based on the total weight of said composition.

13. A method for making an optical sheet comprising:
preparing a mixture of a polymerizable optical composition of claim 1 and a photo-initiator;
applying the mixture on a substrate; and
curing the mixture.

14. The method of claim 13, wherein the photo-initiator is in an amount ranging from 1 to 15 wt % based on the total weight of the mixture.

15. The method of claim 13, wherein the photo-initiator is selected from the group consisting of
1-hydroxy-cyclohexyl-phenyl-ketone,
2-methyl-1-[4-(methylthio)phenyl]-2-(4-morpholinyl)-1-propanone,
phenyl-bis (2,4, 6-trimethylbenzoyl) phosphine oxide,
diphenyl (2,4, 6-trimethylbenzoyl) -phosphine oxide,
2-hydroxy-2-methyl-1-phenyl-1-propanone, and combinations thereof.

16. An optical sheet comprising:
a substrate; and
a brightness enhancement film formed on said substrate;
wherein said brightness enhancement film is formed by: applying a mixture of a polymerizable optical composition of claim 1 and a photo-initiator on said substrate; and curing said mixture to form said brightness enhancement film on said substrate.

17. The optical sheet of claim 16, wherein said brightness enhancement film has a layer thickness ranging from 10 μm to 30 μm.

18. The optical sheet of claim 16, wherein said substrate is made from a material selected from the group consisting of polyethylene terephthalate, polyethylene naphthalate, polyimide, polycarbonate, and polymethyl methacrylate.

19. The optical sheet of claim 16, wherein said substrate is composed of a transparent plastic sheet and a diffusion layer disposed on said sheet and capable of scattering light passing therethrough.
